(19) United States
(12) Patent Application Publication
(10) Pub. No.: US 2025/0053042 A1
(43) Pub. Date: Feb. 13, 2025

(54) DISPLAY PANEL AND DISPLAY DEVICE

(71) Applicant: Xiamen Tianma Optoelectronics Co., Ltd., Xiamen (CN)

(72) Inventors: Zhe PIAO, Xiamen (CN); Xiaoxia HONG, Xiamen (CN); Xuhui PENG, Xiamen (CN); Jiaqi KANG, Xiamen (CN); Chenpeng WANG, Xiamen (CN); Xuyang WENG, Xiamen (CN); Hong CHEN, Xiamen (CN); Qinghao ZHU, Xiamen (CN)

(73) Assignee: Xiamen Tianma Optoelectronics Co., Ltd., Xiamen (CN)

(21) Appl. No.: 18/927,207

(22) Filed: Oct. 25, 2024

(30) Foreign Application Priority Data
Nov. 10, 2023 (CN) 202311502963.7
May 14, 2024 (CN) 202410603080.3

(51) Int. Cl. G02F 1/1335; G02F 1/1333; G02F 1/1339

(52) U.S. Cl. CPC G02F 1/133512; G02F 1/133357; G02F 1/133514; G02F 1/1339

(57) ABSTRACT

Provided are a display panel and a display device. The display panel includes a first substrate and a second substrate disposed opposite to each other, and a liquid crystal layer located between the first substrate and the second substrate. The first substrate is provided with a planarization layer. A surface of a side of the planarization layer facing the liquid crystal layer is provided with multiple groove structures and a protrusion structure located between adjacent groove structures, the second substrate is provided with color film structures which are arranged at intervals, and a color film structure at least partially overlaps with a groove structure in a thickness direction of the display panel. Multiple first support structures are disposed between the first substrate and the second substrate, and a first support structures and the planarization layer are disposed at intervals in the thickness direction of the display panel.

### CROSS-REFERENCE TO RELATED APPLICATION

This application claims priority to Chinese patent application No. 202410603080.3 filed with the China National Intellectual Property Administration (CNIPA) on May 14, 2024, which claims priority to patent application No. 202311502963.7 filed with the CNIPA on Nov. 10, 2023, the disclosures of which are incorporated herein by reference in their entireties.

### TECHNICAL FIELD

The present disclosure relate to the field of display technologies, and in particular to, a display panel and a display device.

### BACKGROUND

A liquid crystal display (LCD) panel is currently the most widely used display product in the market, and has the advantages of mature production process technology, high product yield, relatively low production cost and high market acceptance. Generally, the liquid crystal display panel includes a color film substrate, an array substrate, a liquid crystal sandwiched between the color film substrate and the array substrate, and a sealant. In the related art, the light-shielding layer is usually expanded outwards to improve the squeeze resistance capability, but the aperture ratio is reduced, or the design of the support column opposite to the top is used to increase the aperture ratio, however, the difficulty of the preparation process is increased, and the structure of the liquid crystal display panel needs to be improved.

### SUMMARY

The present disclosure provides a display panel and a display device, to improve the squeeze resistance performance of the display panel, reduce the risk of light leakage, and ensure the display effect of the display panel.

The present disclosure provides a display panel. The display panel includes a first substrate, a second substrate, and a liquid crystal layer. The first substrate and the second substrate are disposed opposite to each other, and the liquid crystal layer is located between the first substrate and the second substrate. The first substrate is provided with a planarization layer, and a surface of a side of the planarization layer facing the liquid crystal layer is provided with multiple groove structures and a protrusion structure located between adjacent groove structures of the multiple groove structures. The second substrate is provided with color film structures which are arranged at intervals, and the color film structure at least partially overlaps with the multiple groove structures in a thickness direction of the display panel. Multiple first support structures are disposed between the first substrate and the second substrate, and the first support structure and the planarization layer are disposed at intervals in the thickness direction of the display panel.

The present disclosure provides a display device. The display device includes the display panel described above.

It should be understood that the contents described in this section are not intended to identify key or critical features of embodiments of the present disclosure, nor intended to limit the scope of the present disclosure. Other features of the present disclosure will be readily understood from the following Description.

### BRIEF DESCRIPTION OF DRAWINGS

In order to describe technical solutions in embodiments of the present disclosure more clearly, the drawings used for describing the embodiments will be briefly introduced below. Apparently, the drawings in the following description are merely some embodiments of the present disclosure. For those of ordinary skill in the art, other drawings may also be obtained according to these drawings without creative labor.

FIG. 1 is a top view of a display panel in a non-squeezed state according to an embodiment of the present disclosure;

FIG. 2 is a cross-sectional view of the display panel in FIG. 1 taken along a cross-sectional line AA′ and a cross-sectional line BB′;

FIG. 3 is a top view of a first substrate according to an embodiment of the present disclosure;

FIG. 4 is a schematic structural diagram of a display panel in a squeezed state according to an embodiment of the present disclosure;

FIG. 5 is another top view of an display panel in a non-squeezed state according to an embodiment of the present disclosure;

FIG. 6 is a cross-sectional view of the display panel in FIG. 5 taken along a cross-sectional line CC′ and a cross-sectional line DD′;

FIG. 7 is another schematic structural diagram of a display panel in a squeezed state according to an embodiment of the present disclosure;

FIG. 8 is another top view of a display panel in a non-squeezed state according to an embodiment of the present disclosure;

FIG. 9 is a cross-sectional view of the display panel in FIG. 8 taken along a cross-sectional line EE′ and a cross-sectional line FF′;

FIG. 10 is another schematic structural diagram of a display panel in a squeezed state according to an embodiment of the present disclosure;

FIG. 11 is another schematic structural diagram of a display panel in a non-squeezed state according to an embodiment of the present disclosure;

FIG. 12 is another schematic structural diagram of a display panel in a squeezed state according to an embodiment of the present disclosure;

FIG. 13 is another schematic structural diagram of a display panel according to an embodiment of the present disclosure;

FIG. 14 is a schematic structural diagram of another display panel according to an embodiment of the present disclosure;

FIG. 15 is another top view of a display panel in a non-squeezed state according to an embodiment of the present disclosure;

FIG. 16 is a cross-sectional view of the display panel in FIG. 15 taken along a cross-sectional line GG′ and a cross-sectional line HH′;

FIG. 17 is another schematic structural diagram of a display panel in a squeezed state according to an embodiment of the present disclosure;

FIG. 18 is a top view of a second substrate according to an embodiment of the present disclosure;

FIG. 19 is a top view of a light-shielding structure according to an embodiment of the present disclosure;

FIG. 20 is another top view of a light-shielding structure according to an embodiment of the present disclosure;

FIG. 21 is another top view of a light-shielding structure according to an embodiment of the present disclosure;

FIG. 22 is another top view of a display panel in a non-squeezed state according to an embodiment of the present disclosure;

FIG. 23 is a cross-sectional view of the display panel in FIG. 22 taken along a cross-sectional line II′ and a cross-sectional line JJ′;

FIG. 24 is another top view of a display panel in a non-squeezed state according to an embodiment of the present disclosure;

FIG. 25 is another top view of a display panel in a non-squeezed state according to an embodiment of the present disclosure;

FIG. 26 is another schematic structural diagram of a display panel in a squeezed state according to an embodiment of the present disclosure;

FIG. 27 is another top view of a display panel in a non-squeezed state according to an embodiment of the present disclosure;

FIG. 28 is another schematic structural diagram of a display panel in a squeezed state according to an embodiment of the present disclosure;

FIG. 29 is another top view of a display panel in a squeezed state according to an embodiment of the present disclosure;

FIG. 30 is another top view of a display panel in a non-squeezed state according to an embodiment of the present disclosure; and

FIG. 31 is a schematic structural diagram of a display device according to an embodiment of the present disclosure.

### DETAILED DESCRIPTION

In order that those skilled in the art will better understand the solutions of the present disclosure, the technical solutions of embodiments of the present disclosure will be clearly and completely described below in conjunction with the accompanying drawings of the embodiments of the present disclosure. Apparently, the described embodiments are merely some embodiments of the present disclosure, rather than all of the embodiments. All other embodiments obtained by those of ordinary skill in the art based on the embodiments of the present disclosure without needing creative efforts shall all fall in the scope of protection of the present disclosure.

It should be noted that the terms “first”, “second” and the like in the description and claims of the present disclosure, and in the foregoing drawings, are used for distinguishing between similar objects and not necessarily for describing a particular order or sequential order. It should be understood that the data so used are interchangeable as appropriate so that the embodiments of the present disclosure described herein can be implemented in an order other than those illustrated or described herein. Moreover, the terms “include” and “have” as well as any variations thereof are intended to cover a non-exclusive inclusion, for example, a process, a method, a system, a product, or an apparatus that includes a series of steps or units is not necessarily limited to those steps or units expressly listed, but may include other steps or units not expressly listed or inherent to such process, method, product, or apparatus.

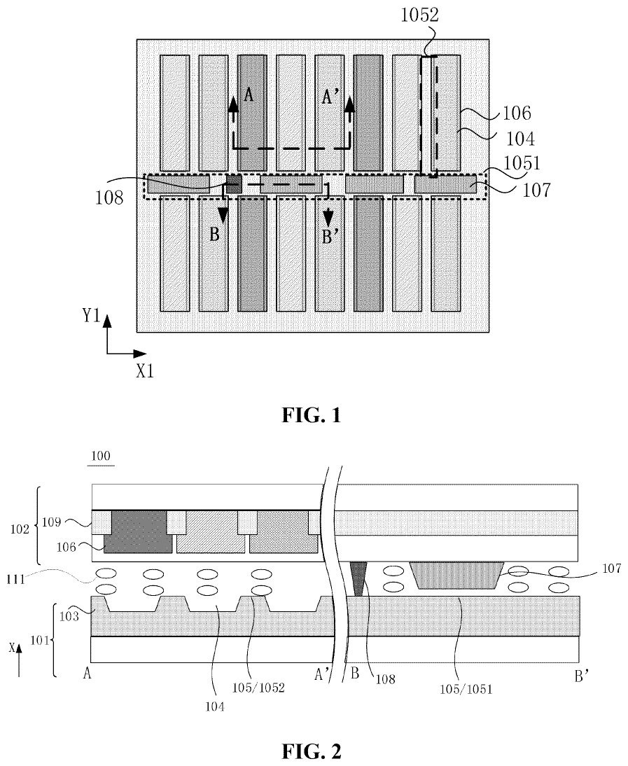

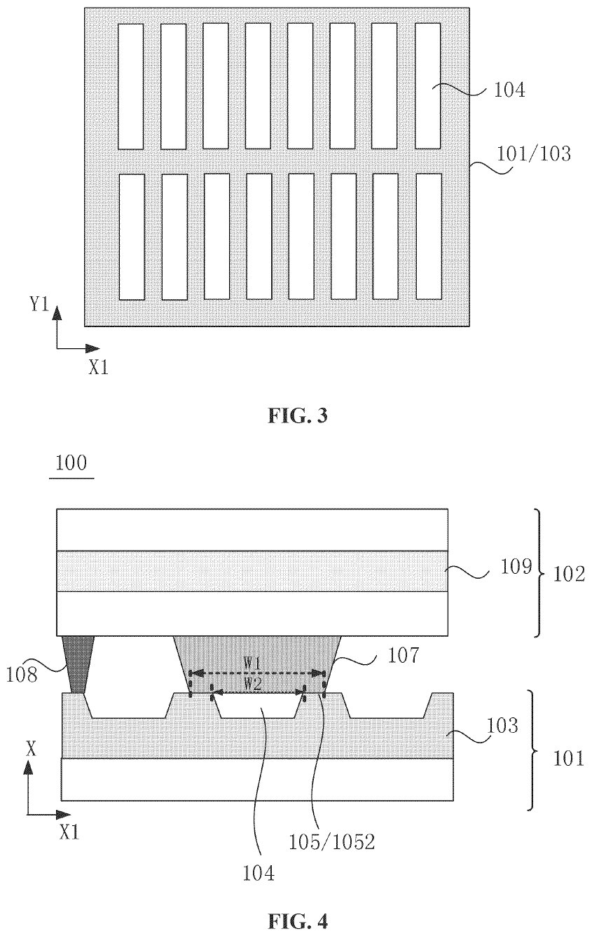

FIG. 1 is a top view of a display panel in a non-squeezed state according to an embodiment of the present disclosure, FIG. 2 is a cross-sectional view of the display panel in FIG. 1 taken along a cross-sectional line AA′ and a cross-sectional line BB′, FIG. 3 is a top view of a first substrate according to an embodiment of the present disclosure, and FIG. 4 is a schematic structural diagram of a display panel in a squeezed state according to an embodiment of the present disclosure. As shown in FIGS. 1 to 4, the display panel 100 includes a first substrate 101, a second substrate 102, and a liquid crystal layer 111. The first substrate 101 and the second substrate 102 are disposed opposite to each other. The liquid crystal layer 111 is located between the first substrate 101 and the second substrate 102. The first substrate 101 is provided with a planarization layer 103, and a surface of a side of the planarization layer 103 facing the liquid crystal layer 111 is provided with multiple groove structures 104 and a protrusion structure 105 located between adjacent groove structures 104. The second substrate 102 is provided with color film structures 106 which are arranged at intervals, and a color film structure 106 at least partially overlaps with a groove structures 104 in a thickness direction X of the display panel 100. Multiple first support structures 107 are disposed between the first substrate 101 and the second substrate 102, and a first support structure 107 and the planarization layer 103 are disposed at intervals in the thickness direction X of the display panel 100.

The first substrate 101 may be an array substrate, and the first substrate 101 may further include multiple scan lines, multiple data lines, and a pixel circuit. The pixel circuit is configured to provide a display signal for a pixel electrode to ensure that the display panel 100 may display normally. In some embodiments, the pixel circuit may include a thin film transistor, the thin film transistor includes an active layer, a gate, a source and a drain, the scan line is electrically connected to the gate, the data line is electrically connected to the source, and the pixel electrode in the first substrate 101 may be electrically connected to the source or the drain through a via to implement the normal transmission of the display signal. The second substrate 102 may be a color film substrate, and the second substrate 102 is provided with the color film structures 106 which are arranged at intervals. The color film structure 106 may include multiple color resist blocks of different colors, such as a red color resist block, a green color resist block, and a blue color resist block, to implement the color display of the display panel 100. A light-shielding unit is disposed between corresponding color film structures 106, and the light-shielding unit is able to avoid optical crosstalk to ensure the display effect of the display panel 100. The liquid crystal layer 111 contains multiple liquid crystal molecules. The liquid crystal molecules may be deflected under the action of an electric field, the light emitted from a backlight module is emitted from the second substrate 102 under the action of the liquid crystal molecules, so that the display panel 100 achieves the display function. The first substrate 101 is provided with the planarization layer 103, and the planarization layer 103 may be disposed to cover the thin film transistor, that is, the planarization layer 103 is disposed on a side of the thin film transistor facing the second substrate 102, to resolve the step difference caused by the thin film transistor. As shown in FIG. 3, the surface of the side of the planarization layer 103 facing the liquid crystal layer 111 is grid-designed, so that the surface of the side of the planarization layer 103 facing the liquid crystal layer is provided with the multiple groove structures 104 and the protrusion structure 105 located between adjacent groove structures. The color film structure 106 at least partially overlaps with the groove structure 104 in the thickness direction X of the display panel 100. Since the groove structures 104 are disposed on a light emission path of the light, a thickness of the planarization layer 103 on the light emission path is reduced, so that the transmittance of light can be improved and the display effect of the display panel 100 can be ensured. The first support structures 107 are disposed between the first substrate 101 and the second substrate 102, and the first support structure 107 and the planarization layer 103 are disposed at intervals, that is, the groove structures 104 are arranged in an array. As shown in FIG. 1, X1 is in a row direction, Y1 is in a column direction, and the row direction X1 and the column direction Y1 may be perpendicular to each other. The multiple scan lines of the first substrate 101 may extend in the row direction X1 and may be arranged in the column direction Y1, and the multiple data lines may extend in the column direction Y1 and may be arranged in the row direction X1. As shown in FIG. 2, when the display panel 100 is not squeezed by an external force, the first support structures 107 and the protrusion structure 105 between two adjacent rows of groove structures in the planarization layer 103 are disposed at intervals. As shown in FIG. 3, when the display panel 100 is squeezed by the external force, a displacement occurs between the first substrate 101 and the second substrate 102, and the first support structures 107 on the first substrate 101 are in contact with part of regions on the planarization layer 103 to play a supporting role, thereby improving the squeeze resistance capability of the display panel 100. In addition, when the display panel 100 is squeeze by the external force, the presence of the first support structures 107 is able to play a certain role of supporting a thickness of a liquid crystal cell, so that the liquid crystal molecules are located in a space supported by the support structure, that is, to enable the liquid crystal molecules to be injected between the array substrate of the display panel 100 and the color film substrate of the display panel 100. Moreover, the groove structures 104 are provided so that the thickness of the liquid crystal cell may be further increased, and thus the display requirement of the display panel 100 can be satisfied. The first support structures 107 and the planarization layer 103 are disposed at intervals in the thickness direction X of the display panel 100, so that when the display panel 100 is squeezed by the external force, the first support structures 107 are in contact with the protrusion structure 105 in the planarization layer 103 to play a supporting role, thereby improving the squeeze resistance capability of the display panel 100. Moreover, as shown in FIG. 4, when display panel 100 is squeezed, the first support structure 107 is firstly in contact with the protrusion structure 105, the first support structure 107 is not in contact with the groove structures 104, that is, the first support structure 107 may be moved to the protrusion structure 105 located adjacent groove structures 104 in the row direction X1, thereby avoiding an alignment film in the groove structures 104 from being scratched by the first support structure 107, preventing the light leakage caused by the scratching of the alignment film, ensuring the capability of resisting light leakage caused by the squeezing of the display panel 10, and further ensuring the display effect of the display panel 100. A larger contact area between the first support structures 107 and the protrusion structure 105 leads to a larger squeeze resistance capability and a lower probability of light leakage caused by the squeezing. A specific contact area may be selected according to practical design requirements, which is not specifically limited in embodiments of the present disclosure.

In embodiments of the present disclosure, the surface of the side of the planarization layer facing the liquid crystal layer is provided with the multiple groove structures and the protrusion structure located between adjacent groove structures, and the color film structure at least partially overlaps with the groove structure in the thickness direction of the display panel to improve the light transmission. The first support structure and the planarization layer are disposed at intervals, when the display panel is squeezed by the external force, the first support structure is in contact with the planarization layer, to increase the surface pressure performance, and improve the squeeze resistance performance of the display panel. Moreover, the first support structures are not in contact with the alignment film in the groove structures, thereby avoiding scratching the alignment film, reducing the risk of light leakage, and ensuring the display effect of the display panel.

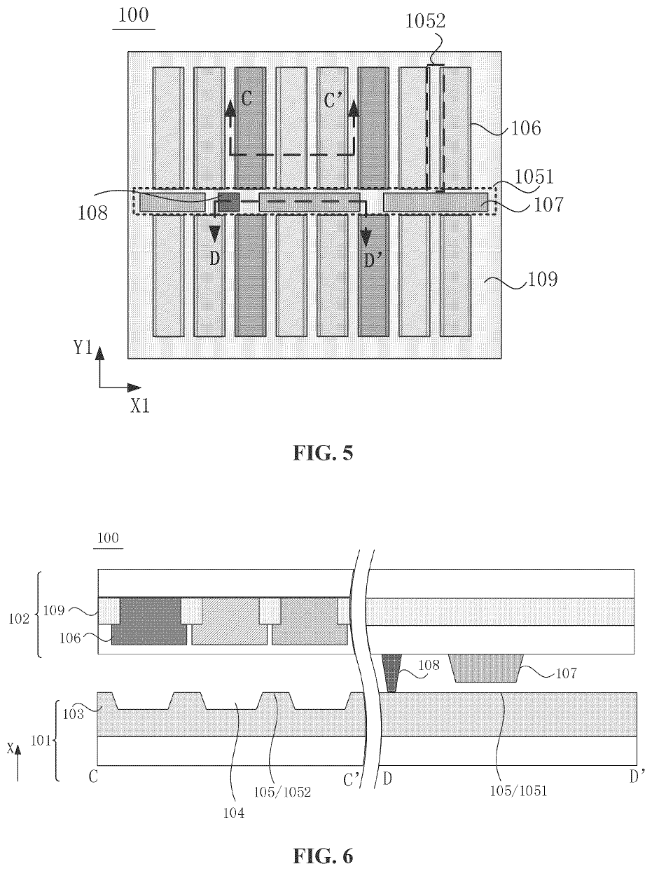

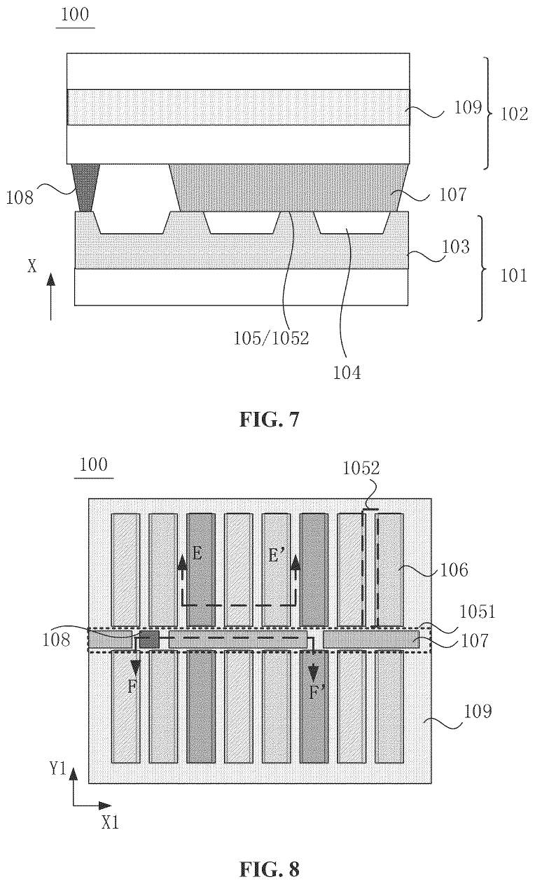

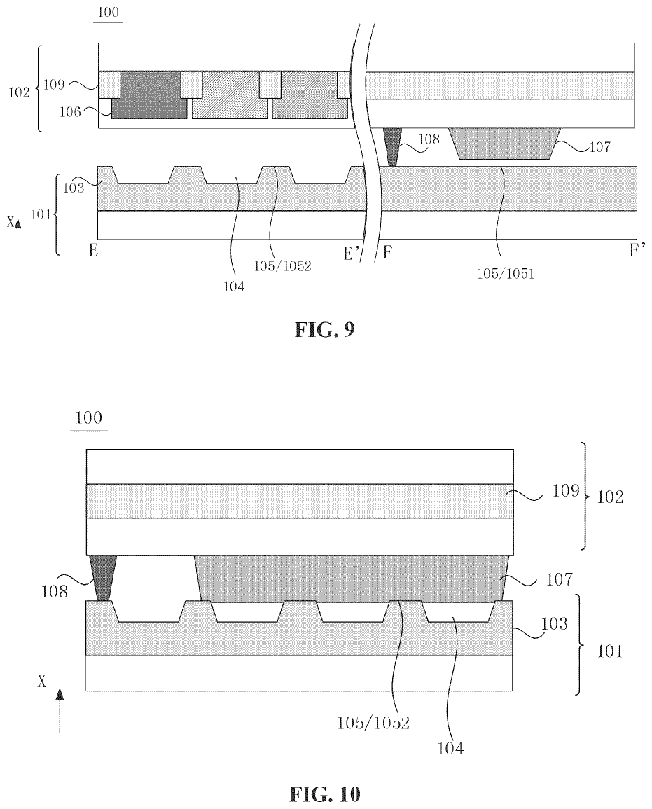

In some embodiments, FIG. 5 is another top view of a display panel in a non-squeezed state according to an embodiment of the present disclosure, FIG. 6 is a cross-sectional view of the display panel in FIG. 5 taken along a cross-sectional line CC′ and a cross-sectional line DD′, FIG. 7 is a schematic structural diagram of another display panel in a squeezed state according to an embodiment of the present disclosure, FIG. 8 is another top view of a display panel in a non-squeezed state according to an embodiment of the present disclosure, FIG. 9 is a cross-sectional view of the display panel in FIG. 8 taken along a cross-sectional line EE′ and a cross-sectional line FF′, and FIG. 10 is another schematic structural diagram of a display panel in a squeezed state according to an embodiment of the present disclosure. As shown in FIGS. 5 to 10, the groove structures 104 are arranged in an array, the protrusion structure 105 includes a first protrusion structure 1051 located between two adjacent rows of groove structures 104, and the first support structure 107 at least partially overlaps with at least one first protrusion structure 1051 in the thickness direction X of the display panel 100.

The protrusion structure 105 includes the first protrusion structure 1051 located between two adjacent rows of groove structures 104 and the second protrusion structure 1052 located between two adjacent columns of groove structures 104. When the display panel 100 is not squeezed by the external force, the first support structure at least partially overlaps with the first protrusion structure 1052 in the thickness direction X of the display panel 100. When the display panel 100 is squeezed by the external force, a relative displacement occurs between the first substrate 101 and the second substrate 102. In some embodiments, as shown in FIG. 4, the first support structure 107 at least partially overlaps with two adjacent second protrusion structures 1052 in the thickness direction X of the display panel 100, so that when the display panel 100 is squeezed by the external force, the first support structure 107 is in contact with the two adjacent second protrusion structures 1052. Since the groove structure 104 at least partially overlaps with the color film structure 106, and moreover, when the first support structure 107 is moved, the first support structure 107 is carried by the second protrusion structure 1052 and is not slided into the groove structure 104, thereby avoiding scratching the alignment film on the planarization layer 103 and ensuring the light emission effect of the display panel 100. As shown in FIG. 7, the first support structure 107 at least partially overlaps with three adjacent second protrusion structures 1052 in the thickness direction X of the display panel 100, when the display panel 100 is squeezed by the external force, the first support structure 107 is in contact with the three adjacent second protrusion structures 1052, thereby further improving the squeeze resistance performance, reducing a probability that the first support structure 107 is slided into the groove structure 104, and reducing the risk of light leakage. Alternatively, as shown in FIG. 10, the first support structure 107 at least partially overlaps with four adjacent second protrusion structures 1052 in the thickness direction X of the display panel 100, so that the capability against the light leakage caused by the squeezing is further improved to ensure the display effect of the display panel 100. In some embodiments, the number of overlapping of the first support structure 107 and the second protrusion structure 1052 may be selected according to practical design requirements, which is not specifically limited in the embodiments of the present disclosure.

In some embodiments, with continued reference to FIG. 4, when the display panel 100 is in a squeezed state, the first support structure 107 at least partially overlaps with at least one groove structure 104 in the thickness direction X of the display panel 100.

In some embodiments, as shown in FIG. 4, when the display panel 100 is in the squeezed state, the first support structure 101 is moved to the second protrusion structure 1052 and is in contact with the second protrusion structure 1052. In the thickness direction X of the display panel 100, the first support structure 107 at least partially overlaps with two adjacent second protrusion structures 1052 and at the same time overlaps with the groove structure 104 located between the two adjacent second protrusion structures 1052, and the groove structure 104 at least partially overlaps with the color film structure 106, thereby improving the squeeze resistance capability of the display panel 100 and ensuring the transmittance of light. No matter how the first support structure 107 is moved, in some embodiments, as shown in FIG. 4, the first support structure 107 is moved to the second protrusion structure 1052 and is carried by the second protrusion structure 1052, so that the first support structure 107 is prevented from falling into the groove structure 104, and further the alignment film in the groove structure 104 corresponding to the color film structure 106 is prevented from being scratched, thereby effectively reducing the risk of light leakage caused by the squeezing.

In some embodiments, with continued reference to FIG. 4, in any plane that is parallel to a vertical light emission direction of the display panel 100, a minimum width of the first support structure 107 is W1, and a maximum width of the groove structure 104 is W2, and W1>W2.

In some embodiments, a cross-sectional shape of the first support structure 107 and a cross-sectional shape of the groove structure 104 are both trapezoidal, the minimum width W1 of the first support structure 107 is greater than the maximum width W2 of the groove structure 104, and the minimum width W1 of the first support structure 107 and the maximum width W2 of the groove structure 104 herein are both a width in the row direction X1, so that an orthographic projection of the groove structure 104 is able to fall within a range of an orthographic projection of the first support structure 107, and when the display panel 100 is squeezed, it is ensured that the first support structure 107 is in contact with the protrusion structure 105 that forms the groove structure 104, thereby ensuring the squeeze resistance capability. Moreover, a width of a surface of a side of the first support structure 107 facing the planarization layer 103 is less than a width of a surface of a side of the first support structure 107 facing away from the planarization layer 103, a width of a surface of a side of the groove structure 104 facing the first support structure 107 is greater than a width of a surface of a side of the groove structure 104 facing away from the first support structure 107, and the width of the surface of the side of the first support structure 107 facing the planarization layer 103 is greater than the width of the surface of the side of the groove structure 104 facing the first support structure 107. The first support structure 107 is supported by adjacent second protrusion structures 1052 in a corresponding groove structure 104, and when the first support structure 107 is moved, the first support structure 107 can be prevented from sliding into the groove structure 104 and scratching the alignment film in the groove structure 104, thereby avoiding the light leakage phenomenon.

In some embodiments, with continued reference to FIG. 1, FIG. 5 and FIG. 8, the display panel 100 further includes a second support structure 108 located between the first substrate 101 and the second substrate 102. In the thickness direction X of the display panel 100, the second support structure 108 is in contact with the surface of the planarization layer 103 facing the liquid crystal layer 111, and the second support structure 108 overlaps with the protrusion structure 105.

The second support structure 108 is also disposed in the display panel 100. In some embodiments, a cross-sectional shape of the second support structure 108 may be trapezoidal, and the second support structure 108 is in contact with the first substrate 101 and the second substrate 102, separately. When the display panel 100 is not squeezed by the external force, the second support structure 108 overlaps with the first protrusion structure 1051 in the thickness direction X of the display panel 100. The second support structure 108 is more sparsely distributed relative to the first support structure 107 and serves to mainly support the thickness of the liquid crystal cell. When the display panel 100 is squeezed by the external force, the second support structure 108 overlaps with the second protrusion structure 1052, and a height of the second support structure 108 changes firstly and then decreases with the decrease of the thickness of the liquid crystal cell. When the second support structure 108 is compressed to a height of the first support structure 107, the first support structure 107 and the second support structure jointly support the thickness of the liquid crystal cell, whereby the consistency of the thickness of the liquid crystal cell is ensured, so that liquid crystal molecules in the liquid crystal cell can fill the entire space in the cell, thereby avoiding the display difference of the display panel 100 caused by the inconsistency of the thickness of the liquid crystal cell and the non-uniform distribution of the liquid crystal molecules, reducing the risk of display chromatic aberration, and further ensuring the optical performance of the display panel 100.

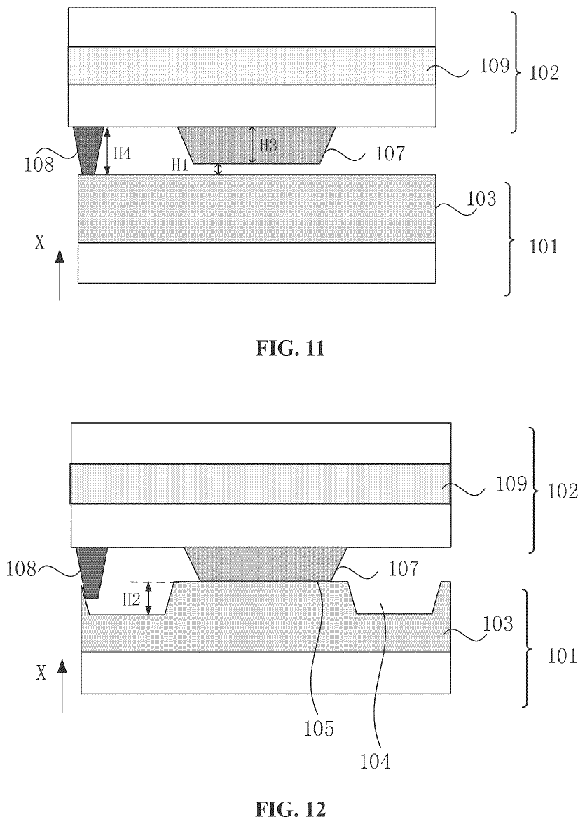

In some embodiments, FIG. 11 is another schematic structural diagram of a display panel in an non-squeezed state according to an embodiment of the present disclosure, and FIG. 12 is another schematic structural diagram of a display panel in a squeezed state according to an embodiment of the present disclosure. As shown in FIG. 11, the display panel 100 further includes a second support structure 108 located between the first substrate 101 and the second substrate 102. When the display panel 100 is in the squeezed state, the first support structure 107 does not overlap with the groove structure 104 in the thickness direction X of the display panel 100.

Multiple second support structures 108 are disposed between the first substrate 101 and the second substrate 102, and part of the second support structures 108 that overlap with the protrusion structure 105 serves to support the thickness of the liquid crystal cell. As shown in FIG. 11, when the display panel is not squeezed by the external force, in the thickness direction X of the display panel 100, the first support structure 107 does not overlap with the groove structure 104, and the first support structure 107 overlaps with the protrusion structure 105. However, as shown in FIG. 12, when the display panel 100 is squeezed by the external force, the first support structure 107 is in contact with the protrusion structure 105, and an orthographic projection of the first support structure 107 falls within a range of an orthographic projection of the protrusion structure 105, and moreover, a width of the first support structure 107 and a width of a protrusion structure 105 corresponding to the first support structure 107 are appropriately disposed, so that the first support structure 107 is prevented from being moved to the groove structure 104 and from scratching the alignment film in the groove structure 104, thus the phenomenon of light leakage caused by the squeezing is avoided, and the yield rate of the display panel 100 is reduced. Depths of the groove structures 104 adjacent to the protrusion structure 105 may be the same or may be different. In some embodiments, in FIG. 12, an example in which the depths of the groove structures 104 adjacent to the protrusion structure 105 are the same is used for illustration. In some embodiments, the design may be performed according to practical design requirements, which is not specifically limited in the embodiment of the present disclosure.

In some embodiments, with continued reference to FIG. 12, when the display panel 100 is in the squeezed state, the second support structure 108 and the planarization layer 103 are disposed at intervals in the thickness direction X of the display panel 100, and the second support structure 108 at least partially overlaps with the groove structure 104.

Multiple second support structures 108 are disposed between the first substrate 101 and the second substrate 102, and part of the second support structures 108 that overlap with the protrusion structure 105 serves to support the thickness of the liquid crystal cell. In some embodiments, in the thickness direction X of the display panel 100, the planarization layer 103 and part of the second support structures 108 are disposed at intervals, and the second support structure 108 at least partially overlaps with the groove structure 104. In this case, when the display panel 100 is squeezed by the external force, the first support structure 107 is firstly in contact with the protrusion structure 105 and decreases with the decrease of the thickness of the liquid crystal cell. In addition, the squeeze resistance capability of the display panel 100 is improved by means of a contact area between the first support structure 107 and the protrusion structure 105, in this case, a depth of the groove structure 104, a height of the first support structure 107, a height of the second support structure 108, and a spacing between the first support structure 107 and the planarization layer 103 are appropriately disposed, when the display panel 100 is squeezed, it is ensured that the second support structures 108 adjacent to the first support structure 107 is not in contact with the groove structure 104, thereby preventing the second support structure 108 from scratching the alignment film in the groove structure 104, avoiding the risk of light leakage of the display panel 100, and ensuring the display effect of the display panel 100.

In some embodiments, with continued reference to FIG. 11 and FIG. 12, in the thickness direction X of the display panel 100, a spacing between the first support structure 107 and the planarization layer 103 is H1, a depth of the groove structure 104 is H2, a height of the first support structure 107 is H3, and a height of the second support structure 108 is H4, where H1<H2 and H4=H3+H1.

When the display panel 100 is squeezed by the external force, the first support structure 107 is firstly in contact with the protrusion structure 105, and the second support structure 108 overlapping with the groove structure 104 is recessed into the groove structure 104. When the display panel 100 is not squeezed by the external force, the height H4 of the second support structure 108 is controlled to be equal to a sum of the height H3 of the first support structure 107 and the spacing H1 between the first support structure 107 and the planarization layer 103, and the depth H2 of the groove structure 104 is controlled to be greater than the spacing H1 between the first support structure 107 and the planarization layer 103, so that the second support structure 108 is not in contact with the bottom of the groove structure 104, thereby avoiding scratching the alignment film in the groove structure 104 and avoiding the risk of light leakage caused by the squeezing.

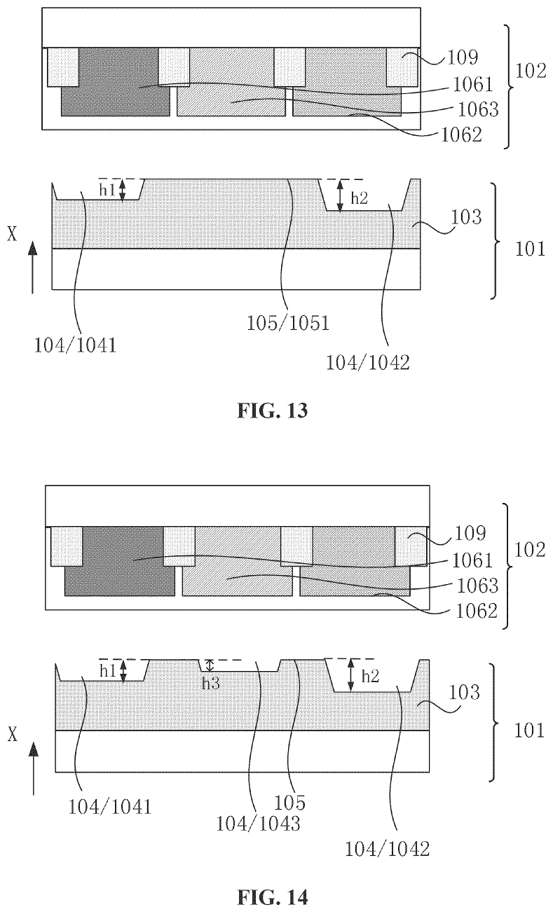

In some embodiments, FIG. 13 is another schematic structural diagram of a display panel according to an embodiment of the present disclosure. As shown in FIG. 13, the color film structure 106 includes at least a first color film structure 1061 and a second color film structure 1062, and a light transmittance of the first color film structure 1061 is greater than a light transmittance of the second color film structure 1062. The groove structure 104 includes a first groove structure 1041 corresponding to the first color film structure 1061 and a second groove structure 1042 corresponding to the second color film structure 1062. A depth h1 of the first groove structure 1041 is less than a depth h2 of the second groove structure 1042 in the thickness direction X of the display panel 100.

To implement the color display of the display panel 100, the color film structure 106 includes the first color film structure 1061 and the second color film structure 1062. Since a color of the first color film structure 1061 is different from a color of the second color film structure 1062, the light transmittance of the first color film structure 1061 is greater than the light transmittance of the second color film structure 1062. Therefore, to balance the light transmittance of the first color film structure 1061 and the light transmittance of the second color film structure 1062, the depth h1 of the first groove structure 1041 corresponding to the first color film structure 1061 may be adjusted to be less than the depth h2 of the second groove structure 1042 corresponding to the second color film structure 1062, thereby ensuring the display uniformity of the display panel 100.

In some embodiments, with continued reference to FIG. 13, the color film structure 106 further includes a third color film structure 1063. A light transmittance of the third color film structure 1063 is greater than a light transmittance of the second color film structure 1062. A first protrusion structure 1051 is provided between the first groove structure 1041 and the second groove structure 104. The third color film structure 1063 overlaps with the first protrusion structure 1051 in the thickness direction X of the display panel 100.

The color film structure 106 is further provided with the third color film structure 1063, the transmittance of the third color film structure 1063 is greater than the transmittance of the second color film structure 1062, that is, the transmittance of the third color film structure 1063 is the largest. To balance light transmittances of color film structures 106 of different colors, a planarization layer 103 corresponding to the third color film structure 1063 may not be designed with the groove structure 104. Since the design of the first groove structure 1041 and the second groove structure 1042, the first protrusion structure 1051 is formed between the first groove structure 1041 and the second groove structure 1042, so that the third color film structure 1063 overlaps with the first protrusion structure 1051 in the thickness direction X of the display panel 100, that is, a thickness of the planarization layer 103 corresponding to the third color film structure 1063 is greater than a thickness of a planarization layer 103 corresponding to the first color film structure 1061, and the thickness of the planarization layer 103 corresponding to the first color film structure 1061 is greater than a thickness of a planarization layer 103 corresponding to the second color film structure 1062, thereby ensuring the display uniformity of the display panel 100.

In some embodiments, FIG. 14 is another schematic structural diagram of a display panel according to an embodiment of the present disclosure. As shown in FIG. 14, the color film structure 106 further includes a third color film structure 1063. A light transmittance of the third color film structure 1063 is greater than a light transmittance of the second color film structure 1062. The groove structure 104 includes a third groove structure 1043 corresponding to the third color film structure 1063, a depth h3 of the third groove structure 1043 is less than a depth h1 of the first groove structure 1041 in the thickness direction X of the display panel 100.

The color film structure 106 is further provided with the third color film structure 1063, a transmittance of the third color film structure 1063 is greater than a transmittance of the second color film structure 1062, that is, the transmittance of the third color film structure 1063 is the largest. To balance light transmittances of color film structures 106 of different colors, a planarization layer 103 corresponding to the third color film structure 1063 may also be designed with the groove structure 104, so that the third color film structure 1063 overlaps with the third groove structure 1043 in the thickness direction X of the display panel 100, a thickness of the planarization layer 103 corresponding to the third color film structure 1063 is greater than a thickness of the planarization layer 103 corresponding to the first color film structure 1061, and the thickness of the planarization layer 103 corresponding to the first color film structure 1061 is greater than a thickness of a planarization layer 103 corresponding to the second color film structure 1062, thereby ensuring the display uniformity of the display panel 100.

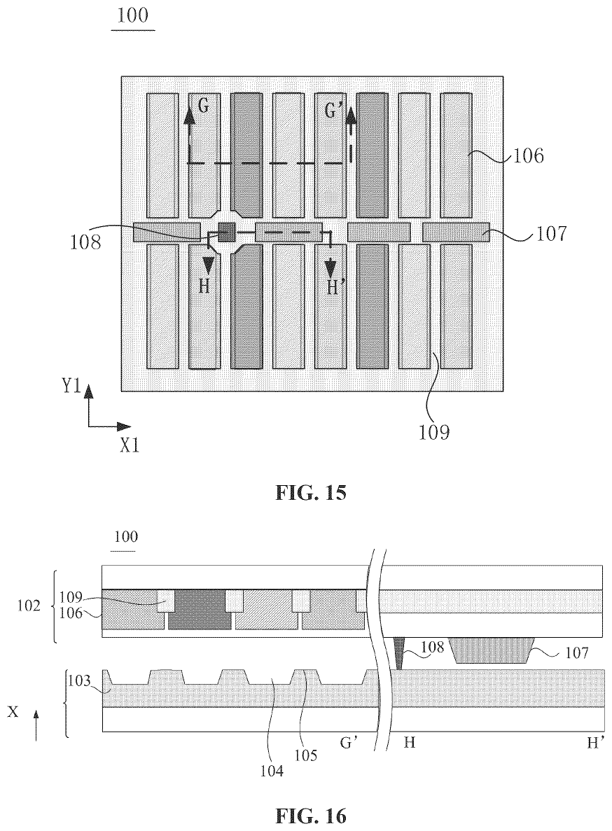

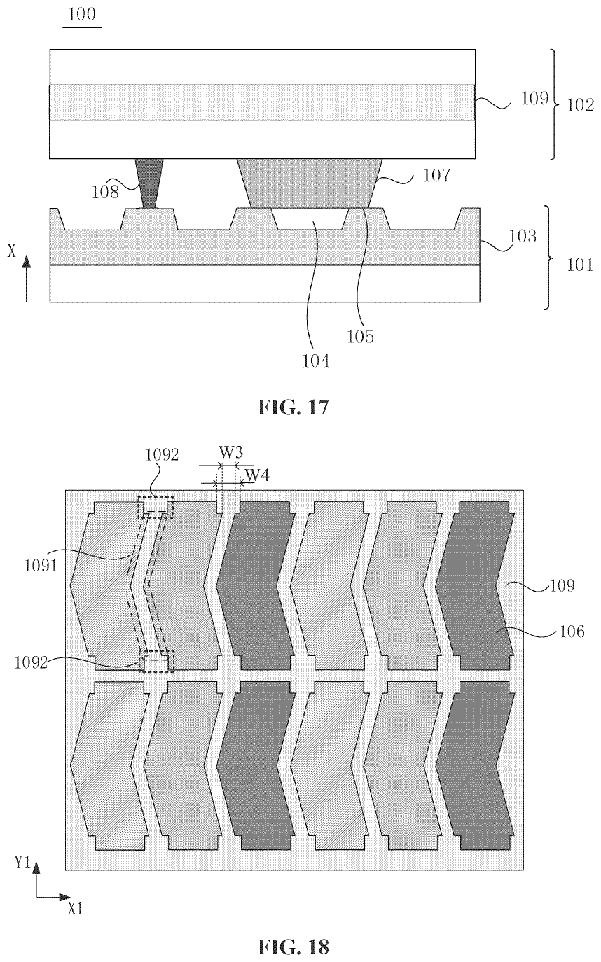

In some embodiments, FIG. 15 is another top view of a display panel in a non-squeezed state according to an embodiment of the present disclosure, FIG. 16 is a cross-sectional view of the display panel in FIG. 15 taken along a cross-sectional line GG′ and a cross-sectional line HH′, and FIG. 17 is another schematic structural diagram of a display panel in a squeezed state according to an embodiment of the present disclosure. As shown in FIGS. 15 to 17, the display panel 100 further includes a light-shielding structure 109 located between adjacent color film structures 106, and the light-shielding structure 109 at least partially overlap with the in the protrusion structure 105 in the thickness X direction of the display panel 100.

The light-shielding structure 109 is disposed between adjacent color film structures 106, and the light-shielding structure 109 can avoid the light leakage from a gap of the color film structure 106, thereby further improving the display effect of the display panel 100. In addition, the light-shielding structure 109 at least partially overlaps with the protrusion structure 105 in the thickness direction X of the display panel 100. As shown in FIG. 15 and FIG. 16, the protrusion structure 105 corresponding to the second support structure 108 is a circular boss, and a coverage area of the protrusion structure 105 is greater than a coverage area of the second support structure 108. The light-shielding structure 109 corresponding to the protrusion structure 105 may be expanded outwards to shield part of the color film structure 106, thereby ensuring the display effect of the display panel 100. In some embodiments, as shown in FIG. 4, FIG. 7 and FIG. 10, when the display panel 100 is squeezed, in the thickness direction X of the display panel 100, the first support structure 107 overlaps with two adjacent protrusion structures 105, the second support structure 108 overlaps with the protrusion structure 105, and the light-shielding structure 109 corresponding to the protrusion structure 105 is not designed to be expanded outwards, to ensure the light transmission area of the color film structure 106, thereby effectively improving an aperture ratio of the display panel 100 and further improving the display effect of the display panel 100.

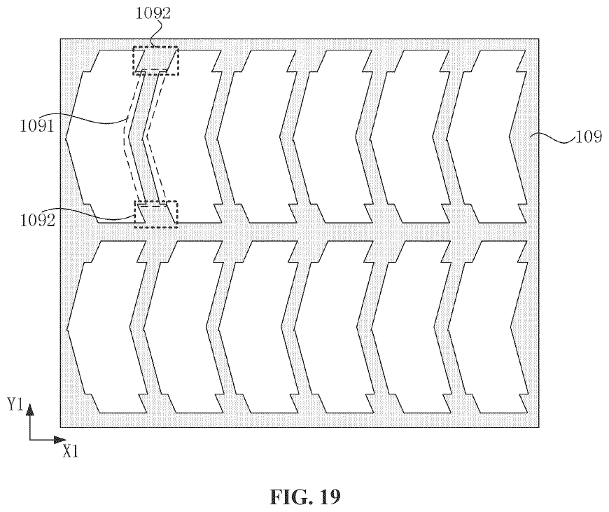

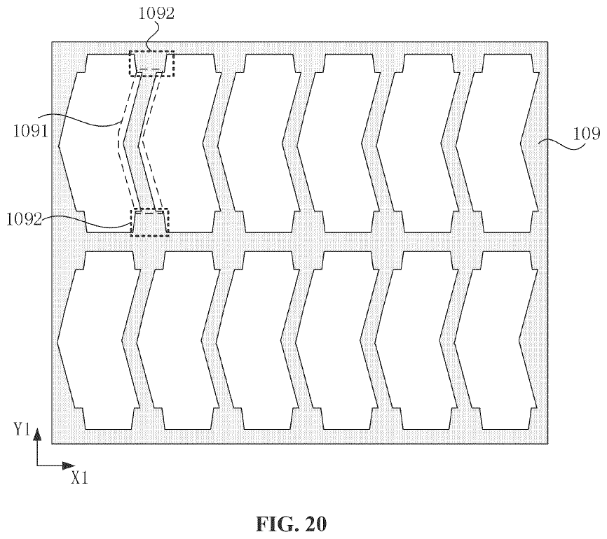

In some embodiments, FIG. 18 is a top view of a second substrate according to an embodiment of the present disclosure. As shown in FIG. 18, the second substrate 102 includes multiple color film structures 106 arranged in an array, the light-shielding structure 109 includes at least a middle light-shielding structure 1091 and an end light-shielding structure 1092 connected to each other, and the middle light-shielding structure 1091 and the end light-shielding structure 1092 are located between two adjacent color film structures 106 in the row direction X1. In any plane that is parallel to a vertical light emission direction of the display panel, an extension width of the middle light-shielding structure is W3, and an extension width of the end light-shielding structure is W4, and W3<W4.

Regarding the light-shielding structure 109 located between the two adjacent color film structures 106 in the row direction X1, the light-shielding structure 109 generally includes the middle light-shielding structure 1091 and two end light-shielding structures 1092. When the display panel 100 is squeezed, the light leakage phenomenon is prone to occur at an edge position. Therefore, the extension width W3 of the middle light-shielding structure 1091 may be adjusted to be less than the extension width W4 of the end light-shielding structure 1092 in any plane that is parallel to the vertical light emission direction of the display panel 100 and in the row direction X1, where both the extension width W3 of the middle light-shielding structure 1091 and the extension width W4 of the end light-shielding structure 1092 are widths in the row direction X1, so that the risk of light leakage can be effectively reduced. Moreover, the extension width of the middle light-shielding structure 1091 is appropriately reduced to reduce the coverage area of the light-shielding structure 109, so that the aperture ratio of the display panel 100 can be effectively increased and the display effect of the display panel 100 can be ensured.

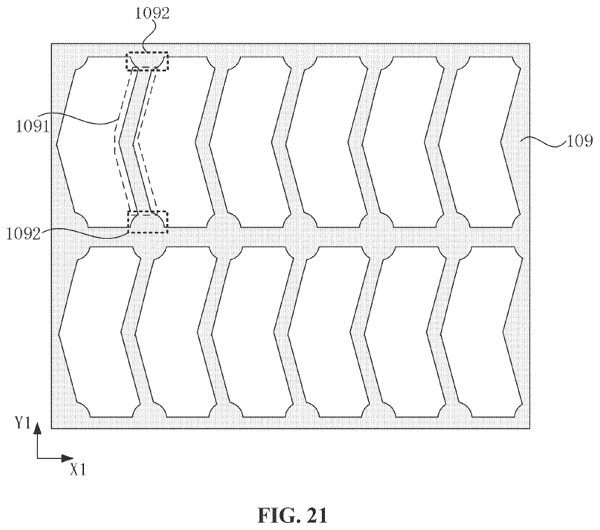

In some embodiments, FIG. 19 is a top view of a light-shielding structure according to an embodiment of the present disclosure, FIG. 20 is another top view of a light-shielding structure according to an embodiment of the present disclosure, and FIG. 21 is another top view of a light-shielding structure according to an embodiment of the present disclosure. As shown in FIGS. 18 to 21, a cross-sectional shape or a top-view shape of the end light-shielding structure 1092 includes at least one of a rectangle, a parallelogram, a trapezoid or a semicircle.

As shown in FIG. 18, the cross-sectional shape of the end light-shielding structure 1092 may be a rectangle, and the top-view shape of the end light-shielding structure 1092 may be a rectangle. As shown in FIG. 19, the cross-sectional shape of the end light-shielding structure 1092 may be a rectangle, and the top-view shape of the end light-shielding structure 1092 may be a parallelogram. As shown in FIG. 20, the cross-sectional shape of the end light-shielding structure 1092 may be a rectangle, and the top-view shape of the end light-shielding structure 1092 may be a trapezoid. As shown in FIG. 21, the cross-sectional shape of the end light-shielding structure 1092 may be a rectangle, and the top-view shape of the end light-shielding structure 1092 may be a semicircle. A specific type may be selected according to practical design requirements, which is not specifically limited in the embodiment of the present disclosure. All the foregoing manners can effectively improve the light leakage resistance capability of the display panel 100 in the squeezed state and improve the aperture ratio of the display panel 100, thereby ensuring the display effect of the display panel 100.

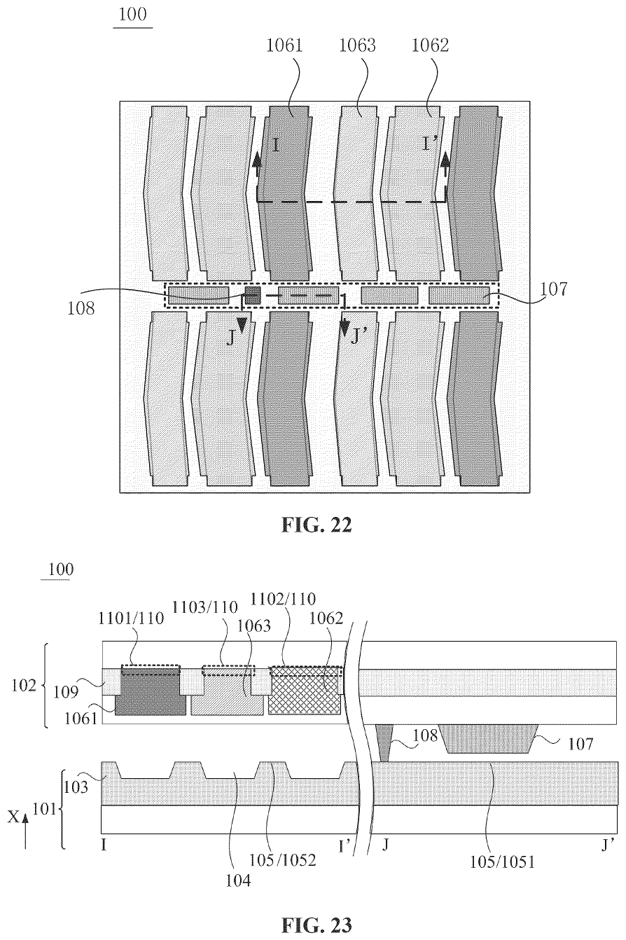

In some embodiments, FIG. 22 is another top view of a display panel in a non-squeezed state according to an embodiment of the present disclosure, and FIG. 23 is a cross-sectional view of the display panel in FIG. 22 taken along a cross-sectional line II′ and a cross-sectional line JJ′. As shown in FIG. 22 and FIG. 23, the display panel 100 further includes a hollow structure 110 located between adjacent light-shielding structures 109, and the hollow structure 110 at least partially overlaps with the color film structure 106 in the thickness direction X of the display panel 100. The color film structure 106 includes at least a first color film structure 1061 and a second color film structure 1062, and a light transmittance of the first color film structure 1061 is greater than a light transmittance of the second color film structure 1062. The hollow structure 110 includes a first hollow structure 1101 corresponding to the first color film structure 1061 and a second hollow structure 1102 corresponding to the second color film structure 1062. An area of the first hollow structure 1061 is less than an area of the second hollow structure 1062 in the thickness direction X of the display panel 100.

A color of the first color film structure 1061 is different from a color of the second color film structure 1062, and the light transmittance of the first color film structure 1061 is greater than the light transmittance of the second color film structure 1062. To balance the display effect of light emitted through the first color film structure 1061 and the second color film structure 1062, the area of the first hollow structure 1101 corresponding to the first color film structure 1061 may be adjusted to be greater than the area of the second hollow structure 1102 corresponding to the second color film structure 1062, so that the area of light transmitted through the first color film structure 1061 is less than the area of light transmitted through the second color film structure 1062, and correspondingly, widths of the light-shielding structures 109 disposed to be adjacent to each other are different, whereby the aperture ratio of the display panel 100 is effectively improved, and thus the overall display uniformity of the display panel 100 is ensured.

In some embodiments, with continued reference to FIG. 22 and FIG. 23, the color film structure 106 further includes a third color film structure 1063, and a light transmittance of the third color film structure 1063 is greater than a light transmittance of the second color film structure 1062. The hollow structure 110 includes a third hollow structure 1103 corresponding to the third color film structure 1063. An area of the third hollow structure 1103 is less than an area of the second hollow structure 1102 in the thickness direction X of the display panel 100.

The color film structure 106 further includes the third color film structure 1063. The light transmittance of the third color film structure 1063 is greater than the light transmittance of the second color film structure 1062. In addition, the light transmittance of the second color film structure 1062 is greater than the light transmittance of the first color film structure 1061. To reduce a difference in the display effect of light emitted from different color film structures 106, the area of the third hollow structure 1103 corresponding to the third color film structure 1063 may be adjusted to be less than the area of the second hollow structure 1102 corresponding to the second color film structure 1062, thereby ensuring the display uniformity of the display panel 100. Moreover, the area of the first hollow structure 1101, the area of the second hollow structure 1102, and the area of the third hollow structure 1103 are appropriately disposed to improve the aperture ratio of the display panel 100.

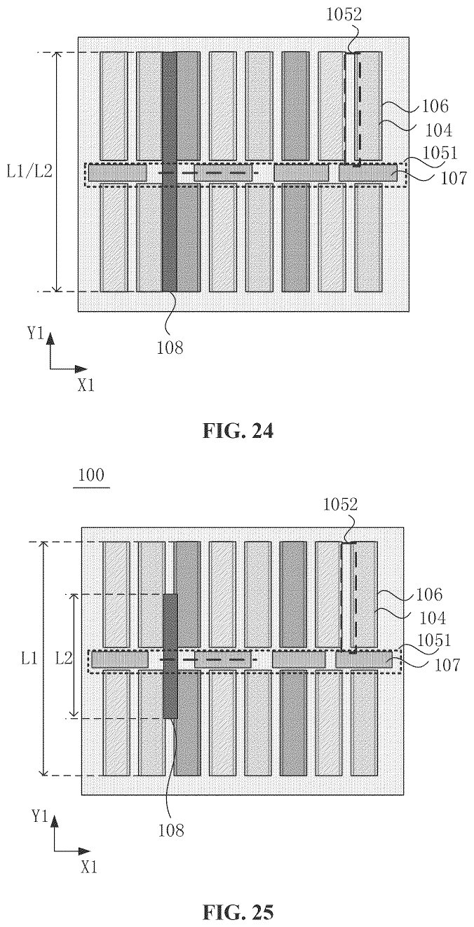

In some embodiments, FIG. 24 is another top view of a display panel in a non-squeezed state according to an embodiment of the present disclosure, and FIG. 25 is another top view of a display panel in a non-squeezed state according to an embodiment of the present disclosure. As shown in FIG. 24 and FIG. 25, the display panel 100 further includes a second support structure 108 located between the first substrate 101 and the second substrate 102. In the thickness direction X of the display panel 100, the second support structure 108 at least partially overlaps with the light-shielding structure 109, and an extension length of the second support structure 108 is less than or equal to an extension length of the light-shielding structure 109.

The second support structure 108 is disposed between the first substrate 101 and the second substrate 102 in the display panel 100. The second support structure 108 may support the thickness of the liquid crystal cell and may be designed in a strip shape in the thickness direction X of the display panel 100, and the light-shielding structure 109 is maintained in an original design, so that the second support structure 108 overlaps with the light-shielding structure 109, and thus the second support structure 108 is able to be shielded by the light-shielding structure 109. In addition, the extension length of the second support structure 108 in the column direction Y1 may be adjusted to be less than or equal to the extension length of the light-shielding structure 109 in the column direction Y1. For example, FIG. 24 shows that the extension width L1 of the light-shielding structure 109 in the column direction Y1 is equal to the extension length L2 of the second support structure in the column direction Y1. For example, FIG. 25 shows that the extension width L1 of the light-shielding structure 109 in the column direction Y1 is greater than the extension length L2 of the second support structure 109 in the column direction Y1. Therefore, the support effect of the second support structure 108 is ensured, the light-shielding structure 109 does not need to be designed to be extended outwards, the aperture difference can be effectively reduced, regular dark spots are improved, and thus the display effect of the display panel 100 is ensured.

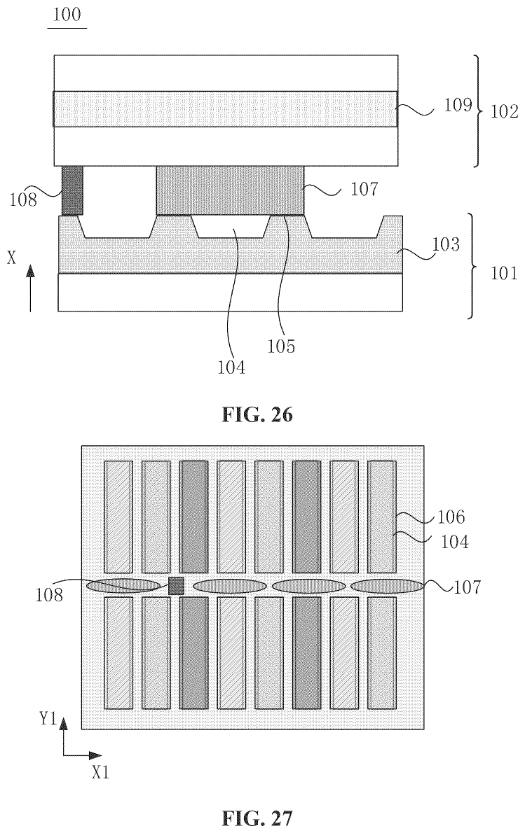

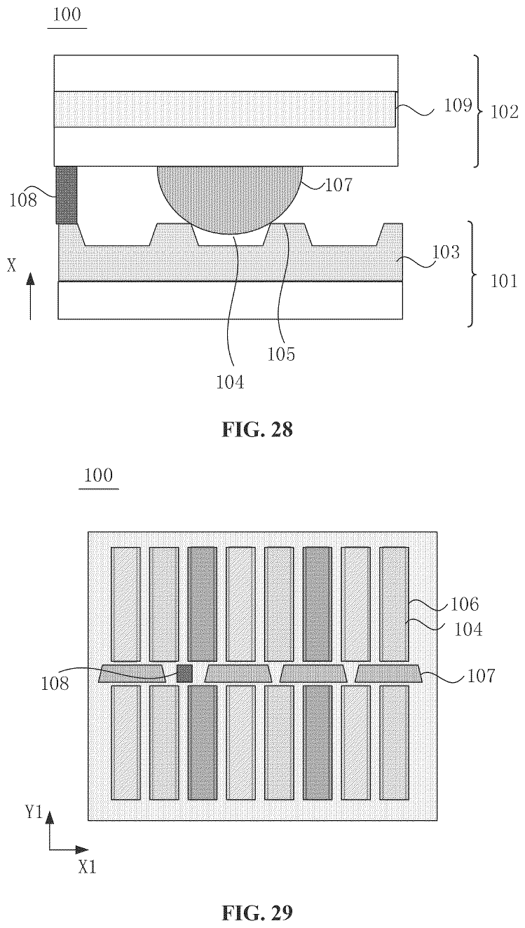

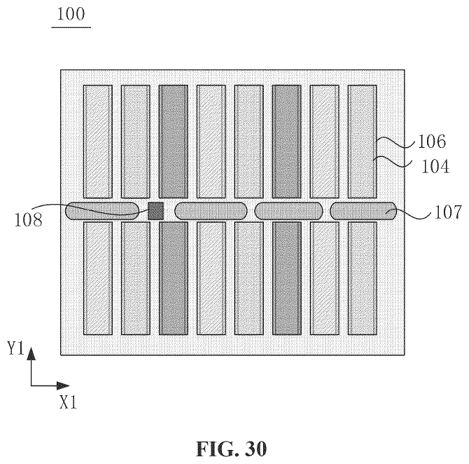

In some embodiments, FIG. 26 is another schematic structural diagram of a display panel in a squeezed state according to an embodiment of the present disclosure, FIG. 27 is another top view of a display panel in a non-squeezed state according to an embodiment of the present disclosure, FIG. 28 is another schematic structural diagram of a display panel in a squeezed state according to an embodiment of the present disclosure, FIG. 29 is another top view of a display panel in a squeezed state according to an embodiment of the present disclosure, and FIG. 30 is another top view of a display panel in a non-squeezed state according to an embodiment of the present disclosure. As shown in FIG. 26 to FIG. 30, a cross-section shape or a top-view shape of the first support structure 107 includes at least one of a rectangle, an ellipse, a semicircle or a trapezoid.

For example, as shown in FIG. 26, the cross-sectional shape of the first support structure 107 may be a rectangle. Alternatively, as shown in FIG. 15 and FIG. 16, the top-view shape of the first support structure 107 is a rectangle, and the cross-sectional shape of the first support structure 107 may be a trapezoid. As shown in FIG. 27 and FIG. 28, the top-view shape of the first support structure 107 is an ellipse, and the cross-sectional shape of the first support structure 107 may be a semicircle. As shown in FIG. 29, the top-view shape of the first support structure 107 is a trapezoid, and a corresponding cross-sectional shape of the first support structure 107 may be a rectangle. As shown in FIG. 30, the top-view shape of the first support structure 107 is an irregular shape, and a corresponding cross-sectional shape of the first support structure 107 may be a rectangle. A specific type may be selected according to practical design requirements, which is not specifically limited in the embodiment of the present disclosure. Similarly, the shape of the second support structure 108 may include at least one of a rectangle, an ellipse, a semicircle, a trapezoid or an irregular shape. The shape of the second support structure 108 in FIGS. 26 to 29 is a rectangle, and a specific type may be selected according to practical design requirements, which is not specifically limited in the embodiments of the present disclosure.

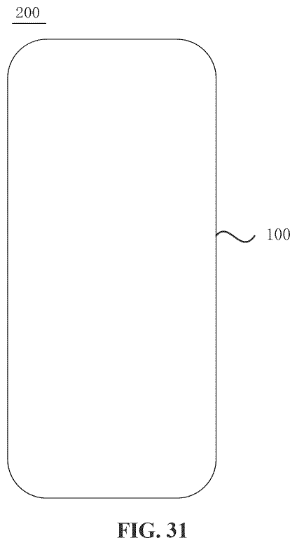

FIG. 31 is a schematic structural diagram of a display device according to an embodiment of the present disclosure. As shown in FIG. 31, the display device 200 includes the display panel 100 described in the above-described embodiments.

It is to be noted that, since the display device provided in this embodiment has the same or corresponding beneficial effect of the display panel 100 in the above-described embodiments, and details are not described herein again. The display device 200 provided in the embodiments of the present disclosure may be a mobile phone shown in FIG. 31, or may be any electronic product having the display function. The any electronic product having the display function includes, but not limited to, the following categories: a television, a notebook computer, a desktop display, a tablet computer, a digital camera, a smart band, smart glasses, an in-vehicle display, a medical apparatus, an industrial control apparatus, and a touch interaction terminal, which is not specifically limited in the embodiments of the present disclosure.

The above implementations should not be construed as limiting the scope of protection of the present disclosure. It should be understood by those skilled in the art that various modifications, combinations, sub-combinations and substitutions may be made, depending on design requirements and other factors. Any modification, equivalent replacement, and improvement made within the spirit and principle of the present disclosure should be included within the scope of protection of the present disclosure.

What is claimed is:

1. A display panel, comprising: a first substrate, a second substrate and a liquid crystal layer, wherein the first substrate and the second substrate are disposed opposite to each other, and the liquid crystal layer is located between the first substrate and the second substrate;
wherein the first substrate is provided with a planarization layer, a surface of a side of the planarization layer facing the liquid crystal layer is provided with a plurality of groove structures and a protrusion structure located between adjacent groove structures of the plurality of groove structures, the second substrate is provided with color film structures which are arranged at intervals, and a color film structure of the color film structures at least partially overlaps with a groove structure of the plurality of groove structures in a thickness direction of the display panel; and
a plurality of first support structures are disposed between the first substrate and the second substrate, and a first support structure of the plurality of first support structures and the planarization layer are disposed at intervals in the thickness direction of the display panel.

2. The display panel of claim 1, wherein in a plane that is parallel to a vertical light emission direction of the display panel, a minimum width of the first support structure is W1, and a maximum width of the groove structure is W2, and W1>W2.

3. The display panel of claim 2, wherein the plurality of groove structures are arranged in an array, the protrusion structure comprises a first protrusion structure located between two adjacent rows of groove structures of the plurality of groove structures, and the first support structure at least partially overlaps with at least one first protrusion structure in the thickness direction of the display panel.

4. The display panel of claim 2, wherein when the display panel is in a squeezed state, the first support structure at least partially overlaps with at least one groove structure of the plurality of the groove structures in the thickness direction of the display panel.

5. The display panel of claim 3, further comprising a second support structure located between the first substrate and the second substrate;
wherein in the thickness direction of the display panel, the second support structure is in contact with a surface of the planarization layer facing the liquid crystal layer, and the second support structure overlaps with the protrusion structure.

6. The display panel of claim 1, further comprising a second support structure located between the first substrate and the second substrate;
wherein in the thickness direction of the display panel, a spacing between the plurality of first support structures and the planarization layer is H1, a depth of the groove structure is H2, a height of the first support structure is H3, and a height of the second support structure is H4, wherein H1<H2, and H4=H3+H1.

7. The display panel of claim 6, wherein when the display panel is in a squeezed state, the first support structure does not overlap with the groove structure in the thickness direction of the display panel.

8. The display panel of claim 7, wherein when the display panel is in a squeezed state, in the thickness direction of the display panel, the second support structure and the planarization layer are disposed at intervals, and the second support structure at least partially overlaps with the groove structures.

9. The display panel of claim 6, wherein the color film structure comprises at least a first color film structure and a second color film structure, and a light transmittance of the first color film structure is greater than a light transmittance of the second color film structure; the groove structure comprises a first groove structure corresponding to the first color film structure and a second groove structure corresponding to the second color film structure, and a depth of the first groove structure is less than a depth of the second groove structure in the thickness direction of the display panel.

10. The display panel of claim 9, wherein the color film structure further comprises a third color film structure, a light transmittance of the third color film structure is greater than the light transmittance of the second color film structure, a first protrusion structure is disposed between the first groove structure and the second groove structure, and the third color film structure overlaps with the first protrusion structure in the thickness direction of the display panel.

11. The display panel of claim 9, wherein the color film structure further comprises a third color film structure, a light transmittance of the third color film structure is greater than the light transmittance of the second color film structure, the groove structure comprises a third groove structure corresponding to the third color film structure, and a depth of the third groove structure is less than the depth of the first groove structure in the thickness direction of the display panel.

12. The display panel of claim 1, further comprising a light-shielding structure located between adjacent color film structures, and the light-shielding structure at least partially overlaps with the protrusion structure in the thickness direction of the display panel.

13. The display panel of claim 12, wherein the second substrate comprises a plurality of color film structures arranged in an array, the light-shielding structure comprises at least a middle light-shielding structure and an end light-shielding structure disposed to be connected to each other, the middle light-shielding structure and the end light-shielding structure are located between two adjacent color film structures of the plurality of color film structures in a row direction; in a plane that is parallel to a vertical light emission direction of the display panel, an extension width of the middle light-shielding structure is W3, and an extension width of the end light-shielding structure is W4, wherein W3<W4.

14. The display panel of claim 13, wherein a cross-sectional shape or a top-view shape of the end light-shielding structure comprises at least one of a rectangle, a parallelogram, a trapezoid or a semicircle.

15. The display panel of claim 13, further comprising a hollow structure located between adjacent light-shielding structures, and the hollow structure at least partially overlaps with the color film structure in the thickness direction of the display panel;
the color film structure comprises at least a first color film structure and a second color film structure, and a light transmittance of the first color film structure is greater than a light transmittance of the second color film structure;
the hollow structure comprises a first hollow structure corresponding to the first color film structure and a second hollow structure corresponding to the second color film structure; and
an area of the first hollow structure is less than an area of the second hollow structure in the thickness direction of the display panel.

16. The display panel of claim 15, wherein the color film structure further comprises a third color film structure, and a light transmittance of the third color film structure is greater than the light transmittance of the second color film structure;
the hollow structure comprises a third hollow structure corresponding to the third color film structure; and
an area of the third hollow structure is less than the area of the second hollow structure in the thickness direction of the display panel.

17. The display panel of claim 12, further comprising a second support structure located between the first substrate and the second substrate; and
in the thickness direction of the display panel, the second support structure at least partially overlaps with the light-shielding structure, and an extension length of the second support structure is less than or equal to an extension length of the light-shielding structure.

18. The display panel of claim 1, wherein a cross-sectional shape or a top-view shape of the first support structure comprises at least one of a rectangle, an ellipse, a semicircle or a trapezoid.

19. A display device, comprising a display panel, wherein the display panel comprises a first substrate, a second substrate and a liquid crystal layer, wherein the first substrate and the second substrate are disposed opposite to each other, and the liquid crystal layer is located between the first substrate and the second substrate;
the first substrate is provided with a planarization layer, a surface of a side of the planarization layer facing the liquid crystal layer is provided with a plurality of groove structures and a protrusion structure located between adjacent groove structures of the plurality of groove structures, the second substrate is provided with color film structures which are arranged at intervals, and a color film structure of the color film structures at least partially overlaps with a groove structure of the plurality of groove structures in a thickness direction of the display panel; and
a plurality of first support structures are disposed between the first substrate and the second substrate, and a first support structure of the plurality of first support structures and the planarization layer are disposed at intervals in the thickness direction of the display panel.

20. The display device of claim 19, wherein in a plane that is parallel to a vertical light emission direction of the display panel, a minimum width of the first support structure is W1, and a maximum width of the groove structure is W2, and W1>W2.
